(19) United States
(12) Patent Application Publication
(10) Pub. No.: US 2023/0352744 A1
(43) Pub. Date: Nov. 2, 2023

(54) JELLY-ROLL TYPE ELECTRODE ASSEMBLY, ELECTROCHEMICAL DEVICE, AND ELECTRONIC DEVICE

(71) Applicant: Ningde Amperex Technology Limited, Ningde (CN)

(72) Inventors: Hongmei WEI, Ningde (CN); Yibo ZHANG, Ningde (CN); Qiuyan WENG, Ningde (CN)

(73) Assignee: Ningde Amperex Technology Limited, Ningde (CN)

(21) Appl. No.: 18/331,405

(22) Filed: Jun. 8, 2023

Related U.S. Application Data
(63) Continuation of application No. PCT/CN2020/134992, filed on Dec. 9, 2020.

(51) Int. Cl. H01M 10/0587; H01M 50/44; H01M 50/446; H01M 4/62; H01M 10/0525

(52) U.S. Cl. CPC H01M 10/0587; H01M 4/622; H01M 10/0525; H01M 50/44; H01M 50/446

(57) ABSTRACT

A jelly-roll type electrode assembly includes an electrode plate and a separation layer disposed on at least one surface of the electrode plate. A bonding force of the separation layer to a surface of the electrode plate in a first region of the jelly-roll type electrode assembly is greater than a bonding force of the separation layer to the surface of the electrode plate in a second region of the jelly-roll type electrode assembly. In this way, the bonding force of the separation layer to the surface of the electrode plate in the first region in the jelly-roll type electrode assembly is relatively high. When the electrode plate in the second region is stressed, a slight slip can occur between layers to release the stress, alleviating deformation of the electrochemical device caused by stress concentration.

### CROSS REFERENCES TO RELATED APPLICATIONS

The present application is a continuation application of international application PCT/CN2020/134992, filed on December 9^{th}, 2020, the disclosure of which is hereby incorporated by reference in its entirety.

### TECHNICAL FIELD

This application relates to the electrochemical field, and in particular, to a jelly-roll type electrode assembly, an electrochemical device, and an electronic device.

### BACKGROUND

By virtue of a high specific energy, a high working voltage, a low self-discharge rate, a small size, a light weight, and other characteristics, lithium-ion batteries are widely used in various fields such as electrical energy storage, portable electronic devices, and electric vehicles. With rapid development of electric vehicles and portable electronic devices, people impose higher requirements on performance of a lithium-ion battery, for example, require the lithium-ion battery to have a higher energy density, higher safety, higher cycle performance, and the like.

A separator of an existing lithium-ion battery usually exists in an electrode assembly as a whole structure, and primarily serves the functions of isolating a positive electrode from a negative electrode, ensuring smooth ion conduction, and isolating electron conduction. Bonding layers of consistent viscosities are usually disposed between the separator and an electrode plate to increase a bonding force between the separator and the electrode plate. However, for the lithium-ion battery that is complicated in shape, due to the particularity of the structure, the forces received in different regions inside the battery are different, and stress concentration is prone to occur in some regions inside the lithium-ion battery, thereby impairing the safety of the lithium-ion battery. Therefore, a new type of lithium-ion battery is urgently needed to improve the safety of the lithium-ion battery.

### SUMMARY

An objective of this application is to provide a jelly-roll type electrode assembly, an electrochemical device, and an electronic device to improve safety of the electrochemical device.

It is hereby noted that in specific embodiments of this application, this application is construed by using a lithium-ion battery as an example of the electrochemical device, but the electrochemical device according to this application is not limited to the lithium-ion battery.

Specific technical solutions are as follows:

A first aspect of this application provides a jelly-roll type electrode assembly. The jelly-roll type electrode assembly includes an electrode plate and a separation layer disposed on at least one surface of the electrode plate. The jelly-roll type electrode assembly includes a first region and a second region. A bonding force of the separation layer to a surface of the electrode plate in the first region of the jelly-roll type electrode assembly is greater than a bonding force of the separation layer to the surface of the electrode plate in the second region of the jelly-roll type electrode assembly. The second region is a rollback region of the jelly-roll type electrode assembly.

Overall, the jelly-roll type electrode assembly according to this application includes a first region and a second region. The second region corresponds to the rollback region of the electrode plate in the jelly-roll type electrode assembly. The first region is a region other than the second region in the jelly-roll type electrode assembly. The bonding force of the separation layer to the surface of the electrode plate in the first region of the jelly-roll type electrode assembly is greater than the bonding force of the separation layer to the surface of the electrode plate in the second region of the jelly-roll type electrode assembly. In this way, the bonding force of the separation layer to the surface of the electrode plate in the first region in the jelly-roll type electrode assembly is relatively high. When the electrode plate in the second region is stressed, a slight slip can occur between layers to release the stress, thereby reducing the probability of stress concentration caused by consistency of bonding forces between the separator and the surface of the electrode plate in existing technology, alleviating deformation of a lithium-ion battery caused by stress concentration during cycling, and in turn, improving the safety of the lithium-ion battery.

In an embodiment of this application, a difference between the bonding force F1 of the separation layer to the surface of the electrode plate in the first region and the bonding force F2 of the separation layer to the surface of the electrode plate in the second region is 1 N/m to 15 N/m, and preferably 5 N/m to 10 N/m. For example, a lower limit of the difference between the bonding force F1 of the separation layer to the surface of the electrode plate in the first region and the bonding force F2 of the separation layer to the surface of the electrode plate in the second region may be, but not limited to, 1 N/m, 2 N/m, 3 N/m, 4 N/m, or 5 N/m; and an upper limit of the difference between the bonding force F1 of the separation layer to the surface of the electrode plate in the first region and the bonding force F2 of the separation layer to the surface of the electrode plate in the second region may be, but not limited to, 6 N/m, 8 N/m, 10 N/m, 12 N/m, or 15 N/m.

By controlling the difference between the bonding force F1 of the separation layer to the surface of the electrode plate in the first region and the bonding force F2 of the separation layer to the surface of the electrode plate in the second region to fall within the above range, this application prevents the electrode plate in the second region from deforming due to stress concentration, thereby improving the safety of the lithium-ion battery.

In an embodiment of this application, the bonding force F1 of the separation layer to the surface of the electrode plate in the first region may be 1 N/m to 30 N/m, and preferably 10 N/m to 20 N/m. Understandably, with the increase of the bonding force F1 of the separation layer to the surface of the electrode plate in the first region, the bonding force F2 of the separation layer to the surface of the electrode plate in the second region increases accordingly, as long as the bonding force F1 of the separation layer to the surface of the electrode plate in the first region is greater than the bonding force F2 in the second region. The bonding force F1 of the separation layer to the surface of the electrode plate in the first region is greater than the bonding force F2 of the separation layer to the surface of the electrode plate in the second region, thereby avoiding deformation of the electrode plate in the second region caused by stress concentration.

In an embodiment of this application, the bonding force F2 of the separation layer to the surface of the electrode plate in the second region may be 2 N/m to 15 N/m, as long as the bonding force F2 of the separation layer to the surface of the electrode plate in the second region is less than the bonding force F1 in the first region, thereby avoiding deformation of the electrode plate in the second region caused by stress concentration.

In an embodiment of this application, the jelly-roll type electrode assembly includes a straight region and a rollback region. The bonding force of the separation layer to the surface of the electrode plate in the straight region is greater than the bonding force of the separation layer to the surface of the electrode plate in the rollback region.

The straight region may be a region in which the electrode plate is flat and straight in the jelly-roll type electrode assembly. The rollback region may be a region in which the electrode plate is rolled back in the jelly-roll type electrode assembly. Generally, stress concentration is more prone to occur in the rollback region of the jelly-roll type electrode assembly because the electrode plate in the rollback region is in a bent state and stressed to a higher degree. A deformation rate of an ordinary lithium-ion battery at the end of 300 cycles is approximately 6% to 7%, but currently a deformation rate of a lithium-ion battery with a high-viscosity separator at the end of 300 cycles is even higher than 10%. An clearance of an interface between the electrode plate and an electrolytic solution in the rollback region is reduced under stress. Consequently, an electrolyte retention space is smaller, electrolyte transmission channels are fewer, and purple specks and lithium plating are prone to occur inside the lithium-ion battery, thereby posing safety hazards. In view of this, the bonding force of the separation layer to the surface of the electrode plate in the straight region in this application may be set to be greater than the bonding force of the separation layer to the surface of the electrode plate in the rollback region. In this way, the bonding force of the separation layer to the surface of the electrode plate in the rollback region is relatively lower. During a charge-and-discharge cycle of the lithium-ion battery that includes the jelly-roll type electrode assembly, a slight slip may occur between layers in the rollback region to release the stress and avoid deformation of the electrode plate in the rollback region caused by stress concentration, thereby improving the safety of the lithium-ion battery.

In an embodiment of this application, the first region may specifically be the straight region of the jelly-roll type electrode assembly, and the second region may specifically be the rollback region of the jelly-roll type electrode assembly. In this case, the bonding force of the separation layer to the surface of the electrode plate in the straight region may be 1 N/m to 30 N/m, and preferably 10 N/m to 20 N/m. With the increase of the bonding force of the separation layer to the surface of the electrode plate in the straight region, the bonding force of the separation layer to the surface of the electrode plate in the rollback region increases accordingly, as long as the bonding force of the separation layer to the surface of the electrode plate in the straight region is greater than the bonding force in the rollback region.

In an embodiment of this application, the electrode assembly according to this application is of a jelly-roll structure, and includes a second region located on the left and right sides of the jelly-roll type electrode assembly and a first region located in the middle of the jelly-roll type electrode assembly. A thickness of the jelly-roll type electrode assembly is denoted as L. Therefore, the second region may be a region covered by a length equal to ½ L measured from an outermost edge on either side of the jelly-roll type electrode assembly to the middle when the jelly-roll type electrode assembly is laid flat. The first region may be a region other than the second region in the jelly-roll type electrode assembly. Understandably, the electrode plate in the second region is curved and rolled back while the electrode plate in the first region is flat and straight.

In an embodiment of this application, the first region of the jelly-roll type electrode assembly may include a first subregion and a second subregion. The first subregion means a region that includes a tab in the first region, that is, a tab region of the jelly-roll type electrode assembly. The second subregion means a region that excludes the tab in the first region. The tab is of a particular thickness. Due to existence of the tab, the electrode plate in the first subregion is more prone to stress concentration. The bonding force F3 of the separation layer to the electrode plate in the second subregion may be greater than the bonding force F4 of the separation layer to the electrode plate in the first subregion, thereby avoiding deformation of the electrode plate in the first subregion caused by stress concentration, and further improving the safety of the lithium-ion battery.

In an embodiment of this application, the bonding force F3 of the separation layer to the electrode plate in the second subregion may be 15 N/m to 20 N/m, and the bonding force F4 of the separation layer to the electrode plate in the first subregion may be 10 N/m to 15 N/m, as long as the bonding force F3 of the separation layer to the electrode plate in the second subregion is greater than the bonding force F4 of the separation layer to the electrode plate in the first subregion.

In an embodiment of this application, the separation layers of different bonding forces to the surface of the electrode plate may be disposed in different regions of the electrode plate, so that the bonding force of the separation layer to the surface of the electrode plate in the first region is greater than the bonding force of the separation layer to the surface of the electrode plate in the second region.

In an embodiment of this application, the bonding force between the separation layer and the surface of the electrode plate may be adjusted and controlled by separation layers containing binders of different viscosities disposed in different regions of the jelly-roll type electrode assembly. For example, a separation layer containing a low-viscosity binder is disposed in the second region, and a separation layer containing a high-viscosity binder is disposed in the first region. In this way, the bonding force of the separation layer to the surface of the electrode plate in the first region is caused to be greater than the bonding force of the separation layer to the surface of the electrode plate in the second region, thereby avoiding deformation of the electrode plate in the second region caused by stress concentration. The viscosity of the binder in the separation layer may be changed by adjusting the content of the binder in the slurry. The high viscosity mentioned in this application may refer to an interfacial bonding force F, satisfying 10 N/m < F ≤ 20 N/m. The low viscosity may refer to an interfacial bonding force F, satisfying 1 N/m ≤ F ≤ 10 N/m.

In an embodiment of this application, the bonding force of the separation layer to the surface of the electrode plate may be adjusted and controlled by increasing the content of the binder in the separation layer in a region that requires a high bonding force. Understandably, the separation layer includes polymer fibers. The polymer fibers may include a binder. In this case, in the first region, a content of the binder in the polymer fibers may be 5 wt% to 25 wt%, and preferably 8 wt% to 17 wt%. For example, a lower limit of the content of the binder in the polymer fibers may be, but not limited to, 5 wt%, 8 wt%, 10 wt%, 12 wt%, or 15 wt%.

Optionally, in the second region, the content of the binder in the polymer fibers may be 2 wt% to 20 wt%, and preferably 6 wt% to 15 wt%. For example, an upper limit of the content of the binder in the polymer fibers may be, but not limited to, 8 wt%, 12 wt%, 15 wt%, 17 wt%, or 20 wt%. In this way, the content of the binder in the polymer fibers in the first region is higher than the content of the binder in the polymer fibers in the second region, so that the bonding force of the separation layer to the surface of the electrode plate in the first region is greater than the bonding force of the separation layer to the surface of the electrode plate in the second region.

In an embodiment of this application, a fiber diameter of the polymer fibers in the separation layer is 10 nm to 5 µm, and preferably 20 nm to 2 µm. For example, a lower limit of the fiber diameter of the polymer fibers may be, but not limited to, 20 nm, 50 nm, 100 nm, or 500 nm; and an upper limit of the fiber diameter of the polymer fibers may be, but not limited to, 1000 nm, 1500 nm, or 2 µm. By controlling the diameter of the polymer fibers to fall within the above range, this application can increase the structural strength of the polymer fibers.

In an embodiment of this application, a thickness of the separation layer is 1 µm to 50 µm, and preferably 3 µm to 15 µm. By controlling the thickness of the separation layer to fall within the above range, this application achieves excellent structural strength of the separation layer without causing excessive thickness of the separation layer, thereby increasing the relative content of an active material in the lithium-ion battery, and in turn, increasing the energy density of the lithium-ion battery.

In an embodiment of this application, the separation layer further includes inorganic particles. A percentage of a volume of the inorganic particles in a total volume of solid matter in the separation layer is not greater than 40%, and preferably, is 15% to 30%. For example, a lower limit of the percentage of the volume of the inorganic particles in the total volume of solid matter in the separation layer may be, but not limited to, 5%, 9%, 18%, or 21%; and an upper limit of the percentage of the volume of the inorganic particles in the total volume of solid matter in the separation layer may be, but not limited to, 24%, 27%, 35%, or 40%. The added inorganic particles can increase the strength of the separation layer.

In an embodiment of this application, an average particle diameter of inorganic particles in the separation layer is 20 nm to 5 µm, and preferably 50 nm to 2 µm. For example, a lower limit of the average particle diameter of the inorganic particles may be, but not limited to, 50 nm, 100 nm, or 500 nm; and an upper limit of the average particle diameter of the inorganic particles may be, but not limited to, 1000 nm, 1500 nm, or 2 µm. By controlling the average particle diameter of the inorganic particles to fall within the above range, this application can further increase the structural strength of the separation layer.

In an embodiment of this application, the inorganic particles may include a binder to improve the adhesion of the inorganic particles. In the first region, a content of the binder in the inorganic particles is 4 wt% to 7 wt%, for example, the content of the binder in the inorganic particles is 4 wt%, 5 wt%, 6 wt%, or 7 wt%.

In the second region, the content of the binder in the inorganic particles is 3 wt% to 15 wt%, for example, the content of the binder in the inorganic particles is 3 wt%, 5 wt%, 7 wt%, 10 wt%, or 15 wt%. As can be seen from the above description, the content of the binder in the inorganic particles in the second region is higher than that in the first region, so that the separation layer in the second region is of higher strength. However, the percentage of the volume of the inorganic particles in the total volume of solid matter in the separation layer is not greater than 40%, indicating that the percentage of the polymer fibers in the separation layer is higher. Therefore, the objectives of this application can be achieved by adjusting the content of the binder in the polymer fibers in the first region and the second region.

In an embodiment of this application, the polymer fibers may further include an inorganic filler. A content of the inorganic filler in the polymer fibers is 5 wt% to 10 wt%. For example, the content of the inorganic filler in the polymer fibers is 5 wt%, 6 wt%, 7 wt%, 8 wt%, 9 wt%, or 10 wt%. By controlling the content of the inorganic filler in the polymer fibers to fall within the above range, this application achieves high structural strength of the polymer fibers. However, the dosage of the inorganic filler needs to be appropriate, and an excessive dosage of the inorganic filler impairs the bonding performance of the polymer fibers.

The polymer fibers are not particularly limited in this application as long as the polymer fibers meet requirements of this application. For example, the polymer fibers may include fibers of at least one of: polyvinylidene fluoride, polyimide, polyamide, polyacrylonitrile, polyethylene glycol, polyethylene oxide, polyphenylene ether, polypropylene carbonate, polymethyl methacrylate, polyethylene terephthalate, poly(vinylidene fluoride-co-hexafluoropropylene), poly(vinylidene difluoride-co-chlorotrifluoroethylene), or a derivative thereof.

The inorganic compound of the inorganic particles in the separation layer is not particularly limited in this application, and the inorganic compound of the inorganic filler in the polymer fibers is not particularly limited in this application, as long as the inorganic compounds meet requirements of this application. For example, the inorganic compounds may include at least one of: hafnium oxide, strontium titanium oxide, tin dioxide, cesium oxide, magnesium oxide, nickel oxide, calcium oxide, barium oxide, zinc oxide, zirconium oxide, yttrium oxide, aluminum oxide, titanium oxide, silicon dioxide, boehmite, magnesium hydroxide, aluminum hydroxide, lithium phosphate, lithium titanium phosphate, lithium aluminum titanium phosphate, lithium lanthanum titanate, lithium germanium thiophosphate, lithium nitride, SiS₂ glass, P₂S₅ glass, lithium oxide, lithium fluoride, lithium hydroxide, lithium carbonate, lithium metaaluminate, lithium germanium phosphorus sulfur ceramics, or garnet ceramics.

The binder is not particularly limited in this application as long as the binder meets requirements of this application. For example, the binder may include at least one of: polyvinyl alcohol, polytetrafluoroethylene, styrene-butadiene rubber, sodium carboxymethyl cellulose, polyacrylic acid, poly(butyl acrylate), polyacrylonitrile, polyurethane, or acrylonitrile multi-polymer.

The method for preparing the separation layer is not particularly limited in this application, and may be any method well known to a person skilled in the art. For example, the separation layer may be prepared by a method that includes the following steps:
dispersing a polymer with a binder added at one weight percent, and with the binder added at another weight percent, in an organic solvent separately to obtain two different slurries; and stirring the slurries well until the viscosity of the slurries are stable, so as to obtain a slurry A and a slurry B respectively, each slurry containing the binder at a different weight percent, and the weight percent of the binder in the slurry A being higher than that in the slurry B;
dispersing inorganic particles with the binders at two different weight fractions in the organic solvent separately to obtain two different slurries, and stirring the slurries well until the viscosity of the slurries is stable, so as to obtain a slurry C and a slurry D, where the weight percent of the binder in the slurry C may be greater than that in the slurry D, or the weight percent of the binder is identical between the slurry C and the slurry D;
spraying the slurry A and the slurry C alternately in a first region of the electrode plate by using an electrospinning device and an electrospray device, so as to obtain a separation layer; and
spraying the slurry B and the slurry D alternately in a second region of the electrode plate by using the electrospinning device and the electrospray device, so as to obtain a separation layer in which the weight percent of the binder in the separation layer in the first region is greater than the weight percent of the binder in the separation layer in the second region, and both the electrospinning device and the electrospray device are connected to a voltage regulator.

To prepare an electrode plate with the separation layer disposed on both sides, the above steps may be repeated on the back side of the electrode plate to obtain an electrode plate with the separation layer disposed on both sides.

In addition, to further increase the strength of the polymer fibers, an inorganic filler such as calcium oxide may be added into a slurry containing the polymer. The inorganic filler and the inorganic particles in this application may be the same inorganic compound, or may be different inorganic compounds respectively.

It is understandable to a person skilled in the art that, in this application, a separation layer may be prepared on the surface of a positive electrode plate, or a separation layer may be prepared on the surface of a negative electrode plate, or a separation layer may be prepared on both the surface of the positive electrode plate and the surface of the negative electrode plate, as long as the bonding force of the separation layer to the surface of the electrode plate is nonuniform between different regions in the jelly-roll type electrode assembly. All such practices fall within the scope of protection of this application.

As an example, the separation layer may be disposed on one side of the positive electrode plate, or the separation layer may be disposed on one side of the negative electrode plate, or the separation layer may be disposed on both sides of the positive electrode plate, or the separation layer may be disposed on both sides of the negative electrode plate, or the separation layer may be disposed on one side of the positive electrode plate and one side of the negative electrode plate, as long as the bonding force of the separation layer to the surface of the electrode plate is nonuniform between different regions in the jelly-roll type electrode assembly.

The positive electrode plate is not particularly limited in this application, as long as the objectives of this application can be achieved. For example, a positive electrode plate generally includes a positive current collector and a positive active material layer. The positive current collector is not particularly limited, and may be any positive current collector well known in the art. For example, the positive current collector may be an aluminum foil, an aluminum alloy foil, or a composite current collector. The positive active material layer includes a positive active material. The positive active material is not particularly limited, and may be any positive active material well known in the prior art. For example, the positive active material may include at least one of lithium nickel cobalt manganese oxide (811, 622, 523, 111), lithium nickel cobalt aluminum oxide, lithium iron phosphate, a lithium-rich manganese-based material, lithium cobaltate, lithium manganate, lithium manganese iron phosphate, or lithium titanate.

The negative electrode plate is not particularly limited in this application, as long as the objectives of this application can be achieved. For example, the negative electrode plate generally includes a negative current collector and a negative active material layer. The negative current collector is not particularly limited, and may be any negative current collector known in the art, for example, a copper foil, an aluminum foil, an aluminum alloy foil, or a composite current collector. The negative active material layer includes a negative active material. The negative active material is not particularly limited, and may be any negative active material known in the art. For example, the negative active material layer may include at least one of artificial graphite, natural graphite, mesocarbon microbeads, soft carbon, hard carbon, silicon, silicon-carbon compound, lithium titanium oxide, or the like.

The lithium-ion battery according to this application further includes an electrolyte. The electrolyte may be one or more of a gel electrolyte, a solid-state electrolyte, and an electrolytic solution. The electrolytic solution includes a lithium salt and a nonaqueous solvent.

In some embodiments of this application, the lithium salt is at least one selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt is LiPF₆ because it provides a high ionic conductivity and improves cycle properties.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the chain carbonate compound are dimethyl carbonate (DMC), diethyl carbonate (DEC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1, 2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl formate, methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or any combination thereof.

This application further provides an electrochemical device. The electrochemical device includes an electrode assembly and an electrolytic solution. The electrode assembly is the jelly-roll type electrode assembly according to any one of the embodiments described above. The electrochemical device achieves high safety performance.

This application further provides an electronic device. The electronic device includes the electrochemical device according to an embodiment of this application, and achieves high safety performance.

The electronic device according to this application is not particularly limited, and may be any electronic device known in the prior art. In some embodiments, the electronic device may include, but without being limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, and the like.

The preparation process of the electrochemical device is well known to a person skilled in the art, and is not particularly limited in this application. For example, a process of manufacturing the electrochemical device may include: stacking a positive electrode and a negative electrode that are separated by a separator, performing operations such as winding and folding as required on the stacked structure, placing the structure into a housing, injecting an electrolytic solution into the housing, and sealing the housing, where the separator in use is the separator provided in this application. In addition, an overcurrent prevention element, a guide plate, and the like may be placed into the housing as required, so as to prevent the rise of internal pressure, overcharge, and overdischarge of the electrochemical device.

In the jelly-roll type electrode assembly according to this application, the bonding force of the separation layer to the surface of the electrode plate in the first region of the jelly-roll type electrode assembly is greater than the bonding force in the second region of the jelly-roll type electrode assembly. In this way, the bonding force of the separation layer to the surface of the electrode plate in the first region in the jelly-roll type electrode assembly is relatively high. When the electrode plate in the second region is stressed, a slight slip can occur between layers to release the stress, thereby reducing the probability of stress concentration caused by consistency of bonding forces between the separator and the surface of the electrode plate in existing technology, alleviating deformation of a lithium-ion battery caused by stress concentration, and in turn, improving the safety of the lithium-ion battery.

### BRIEF DESCRIPTION OF THE DRAWINGS

To describe the technical solutions in this application or the prior art more clearly, the following outlines the drawings to be used in the embodiments of this application or the prior art. Evidently, the drawings outlined below are merely a part of embodiments of this application.

FIG. 1 is a schematic structural diagram of a lithium-ion battery according to an embodiment of this application;

FIG. 2 is a schematic structural diagram of a jelly-roll type electrode assembly (along a surface direction of an electrode plate) according to another embodiment of this application;

FIG. 3 is a schematic structural diagram of a separation layer disposed on a single-side-coated electrode plate according to an embodiment of this application;

FIG. 4 is a schematic structural diagram of a separation layer disposed on a double-side-coated positive electrode plate according to an embodiment of this application;

FIG. 5 is a schematic structural diagram of a separation layer disposed on a double-side-coated negative electrode plate according to an embodiment of this application;

FIG. 6 is a schematic structural diagram of an electrospinning and electrospray device according to an embodiment of this application; and

FIG. 7 is a schematic structural diagram of stacking an electrode plate during a bonding force test according to this application.

Reference Numerals

| | |
|---|---|
| 1 | First Subregion |
| 2 | Second Subregion |
| 3 | Current Collector Layer |
| 4 | Double-Sided Tape |
| 5 | Tension Hold-Down Plate |
| 6 | Pressure Plate |
| 7 | Adhesive Affixing Point |
| 8 | Packaging Bag |
| 9 | Electrode Active Material Layer |
| 10 | Positive Current Collector |
| 11 | Tab |
| 20 | Positve Active Material Layer |
| 30 | Separation Layer |
| 40 | Negative Active Material Layer |
| 50 | Negative Current Collector |
| 60 | Electrospinning Device |
| 70 | Electrospray Device |
| 80 | Votage Regulator |

### DETAILED DESCRIPTION

To make the objectives, technical solutions, and advantages of this application clearer, the following describes this application in further detail with reference to drawings and embodiments. Evidently, the described embodiments are merely a part of but not all of the embodiments of this application. All other embodiments derived by a person of ordinary skill in the art based on the embodiments of this application without making any creative efforts still fall within the protection scope of this application.

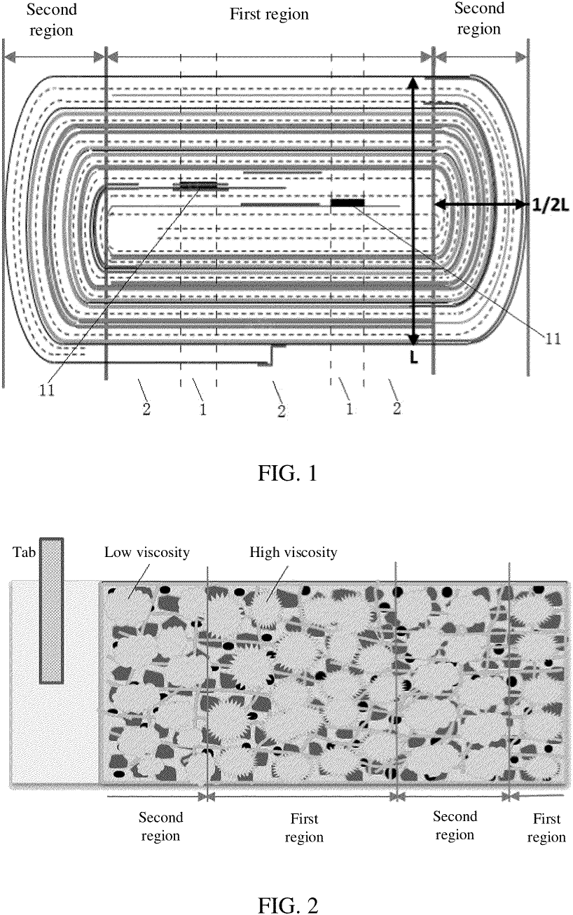

FIG. 1 is a schematic structural diagram of a jelly-roll type electrode assembly according to an embodiment of this application. Referring to FIG. 1, the electrode assembly is of a jelly-roll structure, and includes a second region located on the left and right ends of the jelly-roll type electrode assembly and a first region located in the middle of the jelly-roll type electrode assembly.

As shown in FIG. 1, in an embodiment of this application, the jelly-roll type electrode assembly may include a first subregion 1 and a second subregion 2. The first sub-region 1 means a region that includes a tab 11 in the first region shown in FIG. 1, and the second subregion means a region that excludes the tab 11 in the first region shown in FIG. 1.

FIG. 2 is a schematic structural diagram of a jelly-roll type electrode assembly (along a surface direction of an electrode plate) according to an embodiment of this application. In an embodiment of this application, as shown in FIG. 2, the viscosity of a binder used in the second region is lower than the viscosity of a binder used in the first region, so that the bonding force of the separation layer to the surface of the electrode plate in the first region is greater than the bonding force of the separation layer to the surface of the electrode plate in the second region.

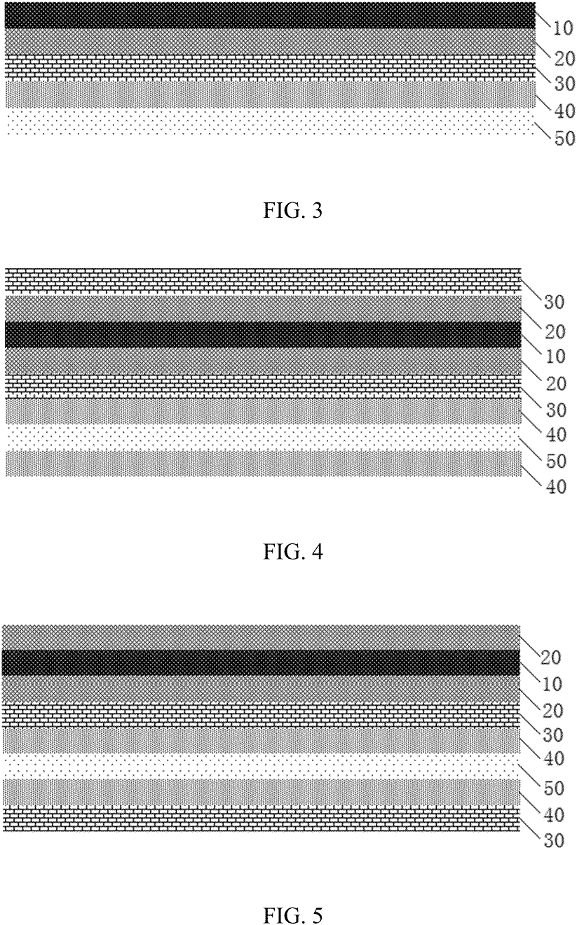

In an embodiment of this application, the separation layer according to this application may be disposed on at least one surface of the electrode plate. For example, the structure may be a structure shown in FIG. 3 in which the separation layer is disposed on one side of the electrode plate, or the structure may be a structure shown in FIG. 4 in which the separation layer is disposed on both sides of a positive electrode plate, or the structure may be a structure shown in FIG. 5 in which the separation layer is disposed on both sides of a negative electrode plate. Specifically, for example, a separation layer 30 is disposed on one surface of the positive electrode plate and one surface of the negative electrode plate, as shown in FIG. 3; the separation layer 30 is disposed on both surfaces of the positive electrode plate, as shown in FIG. 4; and the separation layer 30 is disposed on both surfaces of the negative electrode plate, as shown in FIG. 5. The positive electrode plate includes a positive current collector 10 and a positive active material layer 20. The negative electrode plate includes a negative current collector 50 and a negative active material layer 40.

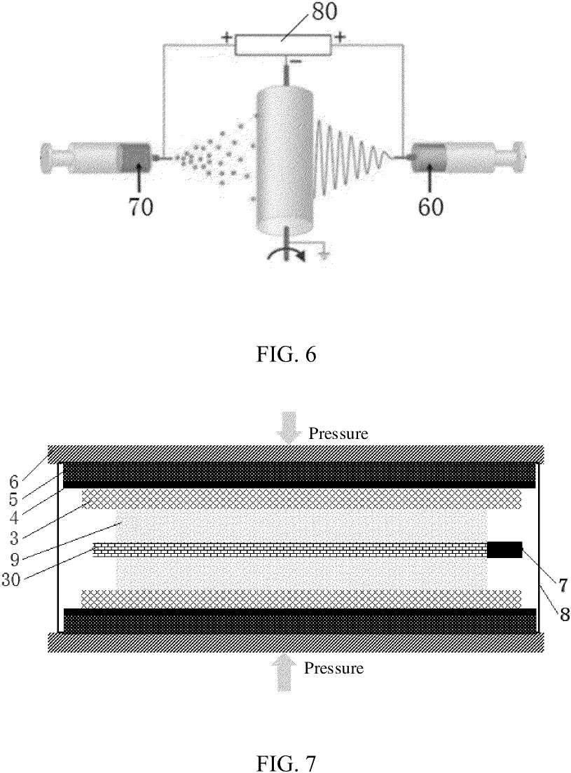

FIG. 6 is a schematic structural diagram of an electrospinning and electrospray device according to an embodiment of this application. The device includes an electrospinning device 60, an electrospray device 70, and a voltage regulator 80.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### Testing the Deformation Severity of a Lithium-Ion Battery

Charging a lithium-ion battery to a half capacity at the time of initially using up a capacity of the lithium-ion battery, that is, at the end of a first charge-and-discharge cycle, measuring the thickness of the lithium-ion battery at 3 positions in each of a first region and a second region (rollback region) separately, and recording the thickness value H₀; keeping the lithium-ion battery in the same charging status (for example, at the same voltage) at the end of 300 charge-and-discharge cycles as the charging status at the time of initially using up the capacity, and measuring the thickness of the lithium-ion battery at the same measurement positions by using the same measurement tool, and recording the thickness value as H₁; and calculating the deformation rate at each measurement position as: deformation rate at the measurement position = (H₁ - H₀)/H₀ × 100%.

Subsequently, averaging out the calculation results at different positions to obtain the deformation rate of the lithium-ion battery.

### Testing the Discharge Energy Density of the Lithium-Ion Battery

Leaving a lithium-ion battery to stand under a normal temperature for 30 minutes, charging the battery at a constant current rate of 0.05 C until the voltage reaches 4.45 V, and then discharging the lithium-ion battery at a 0.05 C rate until the voltage reaches 3.00 V. Repeating the foregoing charge-and-discharge steps for 3 cycles to complete chemical formation of the lithium-ion battery under test. Charging, after completion of the chemical formation, the lithium-ion battery at a constant current rate of 0.2 C and a constant voltage until a voltage of 4.45 V, and then discharging the lithium-ion battery at a rate of 0.2 C until a voltage of 3.00 V. Recording the discharge energy, and then calculating the energy density of the lithium-ion battery discharged at the rate of 0.2 C according to the following formula:

$$\begin{matrix}\text{Energy density} \left(\text{Wh} / \text{L}\right) \text{=} \\ \text{discharge energy} \left(\text{Wh}\right) / \text{volume of lithium-ion battery}\end{matrix} \qquad \text{(L)}$$

### Testing the Capacity Retention Rate of the Lithium-Ion Battery

Performing the same charging process for all the comparative embodiments and the embodiments at an ambient temperature of 25° C.: charging the battery at a constant current of 0.7 C in the constant-current charging stage until the voltage reaches the cut-off voltage of 4.5 V; and then charging the battery at a constant voltage until the current reaches the cut-off current of 0.05 C; leaving the battery to stand for 5 minutes whenever the battery enters a fully charged state, and then discharging the battery at a current of 0.5 C until the voltage reaches 3.0 V, thereby completing a charge-and-discharge cycle. Repeating the charge-and-discharge cycle until 300 cycles are completed, and then dividing a 300^{th}-cycle discharge capacity by a first-cycle discharge capacity to obtain a cycle capacity retention rate.

### Testing the Bonding Force

Cutting an ordinary electrode plate (positive electrode plate or negative electrode plate) and an electrode plate integrated with a separation layer into strips of 50 mm × 100 mm separately, and then stacking the two electrode plates to form a sandwich structure shown in FIG. 7 in such a way that both sides of the separation layer 30 are in contact with the electrode active material layer 9; bonding a tension hold-down plate 5 to a current collector layer 3 through double-sided tape 4; and then putting the sandwich structure into a packaging bag 8 and sealing the bag; adding dropwise an electrolytic solution into the sandwich structure (the composition and concentration of the electrolytic solution are the same as those in the lithium-ion battery); leaving the sandwich structure to stand statically until the surface of the electrode plate integrated with the separation layer is completely wet; putting the packaging bag containing the sandwich structure onto a flat plate of a mechanical press; applying a heating function of a pressure plate 6 until the pressure plate is heated to 90° C.; applying a 1 MPa pressure of the mechanical press for 30 minutes and then unloading the pressure; taking out the pressed object after the pressure plate cools down, and measuring the bonding force.

Taking the hot-pressed sandwich structure specimen out of the packaging bag 8, and relocating the specimen to a tensile tester. Fixing the end of a tensile clamping plate 5 onto a lower chuck of the tensile tester, and keeping the tensile clamping plate vertical to the ground. Fixing an adhesive affixing point 7 of the separation layer 30 onto an upper chuck of the tensile tester, and keeping the upper chuck parallel to the surface of the specimen, Clamping the upper chuck and lower chuck firmly with clamps separately. It is necessary to ensure that the operating console controls the tensile tester to start up, and the tensile test begins after the upper chuck performs pre-stretching. The data is saved after completion of the test.

### Embodiment 1

### <Preparing a Positive Electrode Plate>

### A) <Applying a Positive Active Material>

Mixing lithium cobalt oxide as a positive active material, conductive carbon black, and polyvinylidene difluoride (PVDF) at a mass ratio of 97.5: 1: 1.5, adding N-methylpyrrolidone (NMP) as a solvent, blending the mixture to form a slurry with a solid content of 75%, and stirring well. Coating one surface of a 12 µm-thick aluminum foil with the slurry evenly, and drying the slurry at a temperature of 90° C. to obtain a positive electrode plate coated with a positive active material layer on a single side, where the positive active material layer is 100 µm thick.

### B) <Preparing a Separation Layer>

### Preparing a Slurry:

Using polyvinylidene difluoride (PVDF) as a polymer, using polyvinyl alcohol (PVA) as a binder, and using aluminum oxide (Al₂O₃) as inorganic particles, where the average particle diameter of the inorganic particles is 200 nm.

Dispersing PVDF and PVA in a mixed solvent of dimethylformamide (DMF) and acetone mixed at a ratio of 7: 3, and stirring well until the viscosity of the slurry is stable, so as to obtain a slurry A with a solid content of 25 wt%, in which a mass ratio between PVDF and PVA is 91.3: 8.7.

Dispersing PVDF and PVA in a mixed solvent of DMF and acetone mixed at a ratio of 7: 3, and stirring well until the viscosity of the slurry is stable, so as to obtain a slurry B with a solid content of 25 wt%, in which a mass ratio between PVDF and PVA is 94: 6.

Dispersing Al₂O₃ and PVA in a mixed solvent of DMF and acetone mixed at a ratio of 7: 3, and stirring well until the viscosity of the slurry is stable, so as to obtain a slurry C with a solid content of 40 wt%, in which a mass ratio between Al₂O₃ and PVA is 95.9: 4.1.

Dispersing Al₂O₃ and PVA in a mixed solvent of DMF and acetone mixed at a ratio of 7: 3, and stirring well until the viscosity of the slurry is stable, so as to obtain a slurry D with a solid content of 40 wt%, in which a mass ratio between Al₂O₃ and PVA is 96.8: 3.2.

### Preparing a Separation Layer in the First Region:

Spraying the slurry A and the slurry C alternately in the first region of the electrode plate by using an electrospinning device 60 and an electrospray device 70 shown in FIG. 6, so as to obtain a separation layer that is 7 µm thick.

### Preparing a Separation Layer in the Rollback Region:

Spraying the slurry B and the slurry D alternately in the second region (that is, the rollback region) of the electrode plate by using an electrospinning device 60 and an electrospray device 70, so as to obtain a separation layer that is 7 µm thick. The porosity of the separation layer is 48%, and the fiber diameter of the separation layer is 100 nm.

### C) <Preparing a Double-Side-Coated Electrode Plate>

Repeating the foregoing steps a and b on the back side of the positive electrode plate, and then vacuum-drying the electrode plate at 40° C. to remove the dispersants such as DMF. Subsequently, increasing the temperature to 80° C. and heat-treating the electrode plate for 6 hours (h) to complete a crosslinking process and obtain a positive electrode plate integrated with a separation layer on both sides, and then cutting the positive electrode plate into a sheet of 74 mm × 867 mm in size and welding tabs to the electrode plate for future use.

### <Preparing a Negative Electrode Plate>

Mixing graphite as a negative active material, conductive carbon black, and the styrene butadiene rubber at a mass ratio of 96: 1.5: 2.5, adding deionized water as a solvent, blending the mixture to form a slurry with a solid content of 70%, and stirring well. Coating the negative current collector copper foil with the slurry evenly, and drying the slurry at a temperature of 110° C. Cold-pressing the foil to obtain a negative electrode plate coated with a 150 µm-thick negative active material layer on a single side.

Repeating the same steps as above on the back side of the negative electrode plate to obtain a double-side-coated negative electrode plate. Cutting the negative electrode plate into a sheet of 76 mm × 851 mm in size after completion of the coating, and welding tabs to the electrode plate for future use.

### <Preparing an Electrolytic Solution>

Mixing ethylene carbonate, ethyl methyl carbonate, and diethyl carbonate at a mass ratio of EC: EMC: DEC = 30: 50: 20 in an dry argon atmosphere to form an organic solvent, and then adding a hexafluorophosphate lithium salt into the organic solvent to dissolve, and stirring the solution well to obtain an electrolytic solution in which the lithium salt concentration is 1.15 mol/L.

### <Preparing a Lithium-Ion Battery>

Aligning the prepared negative electrode plate with the positive electrode plate integrated with the separation layer, stacking the electrode plates, and winding the stacked structure into an electrode assembly in such a way that a positive tab and a negative tab are disposed in a first region of the jelly-roll type electrode assembly. Subsequently, affixing adhesive to the endings of the jelly-roll structure, the tabs, and the head of the positive electrode, and putting the electrode assembly into an aluminum-plastic film. Performing top-and-side sealing, electrolyte injection, and sealing to obtain a lithium-ion battery.

### Embodiments 2 to 9

The operations are identical to those in Embodiment 1 except that, in <Preparing a separation layer>, the content of the binder in the slurry A, slurry B, slurry C, and slurry D is adjusted so that the content of the binder in the polymer fibers in the first region, the content of the binder in the inorganic particles in the first region, the content of the binder in the polymer fibers in the second region, and the content of the binder in the inorganic particles in the second region are the values specified in Table 1 for each embodiment. The remaining part is identical to that in Embodiment 1.

### Embodiment 10

The operations are identical to those in Embodiment 1 except that the processes of <preparing a positive electrode plate> and <preparing a negative electrode plate> are different from those in Embodiment 1.

### <Preparing a Positive Electrode Plate>

Mixing lithium cobalt oxide as a positive active material, conductive carbon black, and polyvinylidene difluoride (PVDF) at a mass ratio of 97.5: 1: 1.5, adding N-methylpyrrolidone (NMP) as a solvent, blending the mixture to form a slurry with a solid content of 75%, and stirring well. Coating one surface of a 12 µm-thick aluminum foil with the slurry evenly, and drying the slurry at 90° C. Cold-pressing the foil to obtain a positive electrode plate coated with a 100 µm-thick positive active material layer on a single side. Subsequently, repeating the foregoing steps on the other surface of the positive electrode plate to obtain a positive electrode plate coated with the positive active material layer on both sides. Cutting the positive electrode plate into a size of 74 mm × 867 mm, and welding aluminum tabs to the positive electrode plate for future use.

### <Preparing a Negative Electrode Plate>

### A) <Applying a Negative Active Material>

Mixing graphite as a negative active material, conductive carbon black, and the styrene butadiene rubber at a mass ratio of 96: 1.5: 2.5, adding deionized water as a solvent, blending the mixture to form a slurry with a solid content of 70%, and stirring well. Coating a negative current collector copper foil with the slurry evenly, and drying the slurry at a temperature of 110° C. to obtain a single-side-coated positive electrode plate on which the negative active material layer is approximately 100 µm thick.

### B) <Preparing a Separation Layer>

The operations are identical to those in Embodiment 1 except that the content of the binder in the slurry A, slurry B, slurry C, and slurry D is adjusted so that the content of the binder in the polymer fibers in the first region, the content of the binder in the inorganic particles in the first region, the content of the binder in the polymer fibers in the second region, and the content of the binder in the inorganic particles in the second region of the negative electrode plate are the values specified in Table 1 for Embodiment 10.

### C) <Preparing a Double-Side-Coated Electrode Plate>

Repeating the foregoing steps a and b on the back side of the negative electrode plate, and then vacuum-drying the electrode plate at 40° C. to remove the dispersants such as DMF. Subsequently, increasing the temperature to 80° C. and heat-treating the electrode plate for 6 hours (h) to complete a crosslinking process and obtain a negative electrode plate integrated with a separation layer on both sides, and then cutting the negative electrode plate into a sheet of 74 mm × 851 mm in size for future use.

### Embodiment 11

The operations are identical to those in Embodiment 3 except that the separation layer is applied onto a single side of the positive electrode plate.

### Embodiment 12

The operations are identical to those in Embodiment 3 except that the thickness of the separation layer applied on a single side is adjusted to 3 µm.

### Embodiment 13

The operations are identical to those in Embodiment 3 except that the thickness of the separation layer applied on a single side is adjusted to 15 µm.

### Embodiment 14

The operations are identical to those in Embodiment 3 except that, in <Preparing a separation layer>, the polymer is polyimide, the binder is styrene-butadiene rubber, the inorganic particles are magnesium oxide, the average particle diameter of the inorganic particles is 50 nm, and the fiber diameter of the separation layer is 20 nm.

### Embodiment 15

The operations are identical to those in Embodiment 3 except that, in <Preparing a separation layer>, the polymer is polyacrylonitrile, the binder is sodium carboxymethyl cellulose, the inorganic particles are calcium oxide, the average particle diameter of the inorganic particles is 2 µm, and the fiber diameter of the separation layer is 2 µm.

### Embodiment 16

The operations are identical to those in Embodiment 1 except that, in <Preparing a separation layer>, the content of the binder in the slurry A, slurry B, slurry C, and slurry D is adjusted so that the content of the binder in the polymer fibers in the first region, the content of the binder in the inorganic particles in the first region, the content of the binder in the polymer fibers in the second region, and the content of the binder in the inorganic particles in the second region are the values specified in Table 1 for each embodiment. The remaining part is identical to that in Embodiment 1.

### Embodiment 17

The operations are identical to those in Embodiment 1 except that, in <Preparing a separation layer>, the content of the binder in the slurry A, slurry B, slurry C, and slurry D is adjusted so that the content of the binder in the polymer fibers in the first region, the content of the binder in the inorganic particles in the first region, the content of the binder in the polymer fibers in the second region, and the content of the binder in the inorganic particles in the second region are the values specified in Table 1 for each embodiment. The remaining part is identical to that in Embodiment 1.

### Embodiment 18

The operations are identical to those in Embodiment 1 except that, in <Preparing a lithium-ion battery>, the positive tab and the negative tab are disposed in the second region of the jelly-roll type electrode assembly.

### Embodiment 19

The operations are identical to those in Embodiment 1 except that the process of preparing a separation layer is different from that in Embodiment 1.

### <Preparing a Separation Layer>

### Preparing a Slurry:

Using polyvinylidene difluoride as a polymer, using polyvinyl alcohol as a binder, and using aluminum oxide as inorganic particles, where the average particle diameter of the inorganic particles is 200 nm.

Dispersing PVDF and PVA in a mixed solvent of DMF and acetone mixed at a ratio of 7: 3, and stirring well until the viscosity of the slurry is stable, so as to obtain a slurry A with a solid content of 25 wt%, in which a mass ratio between PVDF and PVA is 83: 17.

Dispersing PVDF and PVA in a mixed solvent of DMF and acetone mixed at a ratio of 7: 3, and stirring well until the viscosity of the slurry is stable, so as to obtain a slurry B with a solid content of 25 wt%, in which a mass ratio between PVDF and PVA is 85.6: 14.4.

Dispersing Al₂O₃ and PVA in a mixed solvent of DMF and acetone mixed at a ratio of 7: 3, and stirring well until the viscosity of the slurry is stable, so as to obtain a slurry C with a solid content of 40 wt%, in which a mass ratio between Al₂O₃ and PVA is 95.2: 4.8.

Dispersing Al₂O₃ and PVA in a mixed solvent of dimethylformamide and acetone mixed at a ratio of 7: 3, and stirring well until the viscosity of the slurry is stable, so as to obtain a slurry D with a solid content of 40 wt%, in which a mass ratio between Al₂O₃ and PVA is 95.5: 4.5.

### Preparing a Separation Layer in the Second Subregion in the First Region:

Spraying the slurry A and the slurry C alternately in the second subregion in the first region of the electrode plate by using an electrospinning device 60 and an electrospray device 70 shown in FIG. 6, so as to obtain a separation layer that is 7 µm thick.

### Preparing a Separation Layer in the First Subregion in the First Region:

Spraying the slurry B and the slurry D alternately in the first subregion in the first region of the electrode plate by using an electrospinning device 60 and an electrospray device 70, so as to obtain a separation layer that is 7 µm thick.

### Preparing a Separation Layer in the Second Region:

Spraying the slurry B and the slurry D alternately in the second region of the electrode plate by using an electrospinning device 60 and an electrospray device 70, so as to obtain a separation layer that is 7 µm thick. The porosity of the separation layer is 48%, and the fiber diameter of the separation layer is 100 nm.

### Embodiment 20

The operations are identical to those in Embodiment 19 except that, in <Preparing a separation layer>, the content of the binder in the slurry A, slurry B, slurry C, and slurry D is adjusted so that the content of the binder in the polymer fibers in the second subregion, the content of the binder in the inorganic particles in the second subregion, the content of the binder in the polymer fibers in the first subregion, and the content of the binder in the inorganic particles in the first subregion are the values specified in Table 2 for Embodiment 20. The remaining part is identical to that in Embodiment 19.

### Embodiment 21

The operations are identical to those in Embodiment 19 except that, in <Preparing a separation layer>, the content of the binder in the slurry A, slurry B, slurry C, and slurry D is adjusted so that the content of the binder in the polymer fibers in the second subregion, the content of the binder in the inorganic particles in the second subregion, the content of the binder in the polymer fibers in the first subregion, and the content of the binder in the inorganic particles in the first subregion are the values specified in Table 2 for Embodiment 21. The remaining part is identical to that in Embodiment 19.

### Comparative Embodiment 1

### <Preparing a Positive Electrode Plate>

Mixing lithium cobalt oxide as a positive active material, conductive carbon black, and polyvinylidene difluoride (PVDF) at a mass ratio of 97.5: 1: 1.5, adding N-methylpyrrolidone (NMP) as a solvent, blending the mixture to form a slurry with a solid content of 75%, and stirring well. Coating one surface of a 12-µm thick aluminum foil with the slurry evenly, and drying the slurry at 90° C. Cold-pressing the foil to obtain a positive electrode plate coated with a positive active material layer that is 100 µm thick. Subsequently, repeating the foregoing steps on the other surface of the positive electrode plate to obtain a positive electrode plate coated with the positive active material layer on both sides. Cutting the positive electrode plate into a size of 74 mm × 867 mm, and welding aluminum tabs to the positive electrode plate for future use.

### <Preparing a Negative Electrode Plate>

Mixing graphite as a negative active material, conductive carbon black, and the styrene butadiene rubber at a mass ratio of 96: 1.5: 2.5, adding deionized water as a solvent, blending the mixture to form a slurry with a solid content of 70%, and stirring well. Coating the negative current collector copper foil with the slurry evenly, and drying the slurry at a temperature of 110° C. Cold-pressing the foil to obtain a negative electrode plate coated with a 150 µm-thick negative active material layer on a single side.

Repeating the same steps as above on the back side of the negative electrode plate to obtain a double-side-coated negative electrode plate. Cutting the negative electrode plate into a sheet of 76 mm × 851 mm in size after completion of the coating, and welding tabs to the electrode plate for future use.

### <Preparing a Separator>

The separator is a porous polyethylene (PE) separator, the average pore diameter is 0.073 µm, the porosity is 26%, and the thickness of the separator is 20 µm.

### <Preparing an Electrolytic Solution>

Mixing ethylene carbonate, ethyl methyl carbonate, and diethyl carbonate at a mass ratio of EC: EMC: DEC = 30: 50: 20 in an dry argon atmosphere to form an organic solvent, and then adding a hexafluorophosphate lithium salt into the organic solvent to dissolve, and stirring the solution well to obtain an electrolytic solution in which the lithium salt concentration is 1.15 mol/L.

### <Preparing a Lithium-Ion Battery>

Aligning the prepared positive electrode plate with the separator and the negative electrode plate, stacking them and winding the stacked structure into an electrode assembly. Affixing adhesive to the endings of the jelly-roll structure, the tabs, and the head of the positive electrode, and putting the electrode assembly into an aluminum-plastic film. Performing top-and-side sealing, electrolyte injection, and sealing to obtain a lithium-ion battery.

### Comparative Embodiment 2

The operations are identical to those in Comparative Embodiment 1 except that the process of <Preparing a separator> is different from that in Comparative Embodiment 1.

### <Preparing a Separator>

Mixing Al₂O₃ and polyacrylate at a mass ratio of 90: 10, and dissolving the mixture in deionized water to form a ceramic slurry with a solid content of 50%. Subsequently, coating one side of a polyethylene (PE) porous substrate (thickness: 7 µm; average pore diameter: 0.073 µm; porosity: 26%) with the ceramic slurry evenly by a micro-gravure coating method. Drying the slurry to obtain a double-layer structure of the ceramic coating and the porous substrate, in which the thickness of the ceramic coating is 50 µm.

Mixing PVDF and polyacrylate at a mass ratio of 96: 4, and dissolving the mixture in deionized water to form a polymer slurry with a solid content of 50%. Subsequently, coating both surfaces of the double-layer structure of the ceramic coating and the porous substrate with the polymer slurry evenly by a micro-gravure coating method, and drying the slurry to obtain a separator, in which the thickness of a single coating layer formed by the polymer slurry is 2 µm.

### Comparative Embodiment 3

The operations are identical to those in Comparative Embodiment 1 except that the separator is made of non-woven fabric that is 20 µm thick.

### Comparative Embodiment 4

The operations are identical to those in Embodiment 1 except that the process of <Preparing a positive electrode plate> is different from that in Embodiment 1.

### <Preparing a Positive Electrode Plate>

### A) <Applying a Positive Active Material>

Mixing lithium cobalt oxide as a positive active material, conductive carbon black, and PVDF at a mass ratio of 97.5: 1: 1.5, adding NMP as a solvent, blending the mixture to form a slurry with a solid content of 75%, and stirring well. Coating one surface of a 12 µm-thick aluminum foil with the slurry evenly, and drying the slurry at a temperature of 90° C. to obtain a positive electrode plate coated with a positive active material layer on a single side, where the positive active material layer is 100 µm thick.

### B) <Preparing a Separation Layer>

Dispersing PVDF and low-melting PE (with a melting point of 90° C. to 115° C.) in a mixed solvent of DMF and acetone mixed at a ratio of 7: 3, and stirring well until the viscosity of the slurry is stable, so as to obtain a slurry E with a solid content of 25 wt%, in which a mass ratio between PVDF and the low-melting PE is 82: 18.

Dispersing Al₂O₃ and low-melting PE in a mixed solvent of NMP and acetone mixed at a ratio of 7: 3, and stirring well until the viscosity of the slurry is stable, so as to obtain a slurry F with a solid content of 40 wt%, in which a mass ratio between Al₂O₃ and the low-melting PE is 95: 5.

Spraying the slurry E onto the surface of the positive electrode plate by using the electrospinning device 60 shown in FIG. 6, so as to obtain a 10 µm-thick fiber layer compounded of PVDF and PE, where the average pore diameter of the fiber layer is 100 nm, and the porosity of the fiber layer is 50%. Subsequently, spraying the slurry F onto the surface of the PVDF+PE fiber layer by using an electrospray device 70, so as to form a 12 µm-thick separation layer.

### C) <Preparing a Double-Side-Coated Electrode Plate>

Repeating the foregoing steps a and b on the back side of the positive electrode plate, and then vacuum-drying the electrode plate at 40° C. to remove the dispersants such as DMF. Subsequently, increasing the temperature to 80° C. and heat-treating the electrode plate for 6 hours (h) to complete a crosslinking process and obtain a positive electrode plate integrated with a separation layer on both sides, and then cutting the positive electrode plate into a sheet of 74 mm × 867 mm in size and welding tabs to the electrode plate for future use.

The preparation parameters and test results of the embodiments and comparative embodiments are shown in Table 1 and Table 2 below:

TABLE 1

Test parameters and test results of Embodiments 1 to 18 and each comparative embodiment

| | Bonding force in first region (N/m) | Bonding force in second region (N/m) | Bonding force difference (N/m) | Content of binder in polymer fibers in first region (wt%) | Content of binder in inorganic particles in first region (wt%) | Content of binder in polymer fibers in second region (wt%) | Content of binder in inorganic particles in second region (wt%) | Volume percent of inorganic particles in separation layer | Single-side thickness of separation layer (µm) | 300^{th}-cycle deformation of lithium-ion battery (%) | Volumetric energy density of battery discharged at 0.2 C (wh/L) | 300^{th}-cycle capactiy retention rate (%) |
|---|---|---|---|---|---|---|---|---|---|---|---|---|
| Embodiment 1 | 11 | 9 | 2 | 8.7 | 4.1 | 6 | 3.2 | 17 | 7 | 8.6 | 720.0 | 90.7 |
| Embodiment 2 | 14 | 9 | 5 | 14 | 4.5 | 6.8 | 4.3 | 17 | 7 | 7.8 | 721.0 | 91.5 |
| Embodiment 3 | 18 | 10 | 8 | 17 | 4.8 | 6.5 | 4.5 | 17 | 7 | 6.5 | 725.4 | 92.8 |
| Embodiment 4 | 17 | 15 | 2 | 17 | 4.8 | 14.4 | 4.5 | 17 | 7 | 8.9 | 719.3 | 90.6 |
| Embodiment 5 | 17 | 12 | 5 | 17 | 4.8 | 10.6 | 4.5 | 17 | 7 | 8.1 | 722.6 | 91.8 |
| Embodiment 6 | 18 | 9 | 9 | 17 | 4.8 | 6.8 | 4.5 | 17 | 7 | 6.9 | 723.2 | 92 |
| Embodiment 7 | 16 | 14 | 2 | 16.5 | 7 | 12 | 15 | 20 | 7 | 8.3 | 716.4 | 90.5 |
| Embodiment 8 | 15 | 10 | 5 | 16.5 | 7 | 9.5 | 9.8 | 18 | 7 | 8.7 | 718.9 | 90.8 |
| Embodiment 9 | 15 | 8 | 7 | 16.5 | 7 | 6.5 | 5.2 | 15 | 7 | 7.4 | 720.3 | 91.4 |
| Embodiment 10 | 17 | 9 | 8 | 17 | 4.8 | 6.5 | 4.5 | 17 | 7 | 6.8 | 721.7 | 91.6 |
| Embodiment 11 | 19 | 10 | 9 | 17 | 4.8 | 6.5 | 4.5 | 17 | 7 | 7.4 | 723.3 | 91.5 |
| Embodiment 12 | 12 | 5 | 7 | 17 | 4.8 | 6.5 | 4.5 | 17 | 3 | 8.5 | 726.1 | 90.7 |
| Embodiment 13 | 18 | 9 | 9 | 17 | 4.8 | 6.5 | 4.5 | 17 | 15 | 6.4 | 717.3 | 92.9 |
| Embodiment 14 | 16 | 7 | 9 | 17 | 4.8 | 6.5 | 4.5 | 17 | 7 | 7.1 | 716.0 | 91.3 |
| Embodiment 15 | 14 | 5 | 9 | 17 | 4.8 | 6.5 | 4.5 | 17 | 7 | 8.2 | 715.4 | 90.6 |
| Embodiment 16 | 3 | 2 | 1 | 5 | 4 | 2 | 3 | 17 | 7 | 8.9 | 725.2 | 89.6 |
| Embodiment 17 | 28 | 14 | 14 | 25 | 7 | 20 | 15 | 17 | 7 | 7.0 | 710.6 | 92.1 |
| Embodiment 18 | 11 | 9 | 2 | 8.7 | 4.1 | 6 | 3.2 | 17 | 7 | 8.7 | 716.0 | 90.5 |
| Comparative Embodiment 1 | - | - | - | 2 | - | 2 | - | - | - | 9.3 | 680 | 88.5 |
| Comparative Embodiment 2 | - | - | - | 15 | - | 15 | - | - | - | 12 | 702 | 90.4 |
| Comparative Embodiment 3 | - | - | - | - | - | - | - | - | - | 6.2 | 650 | 89.1 |
| Comparative Embodiment 4 | - | - | - | 18 | 5 | 18 | 5 | 25.5 | - | 10.2 | 715 | 90.1 |

TABLE 2

Test parameters and test results of Embodiments 19 to 21

| | Bonding force in second subregion (N/m) | Bonding force in first subregion (N/m) | Bonding force difference (N/m) | Content of binder in polymer fibers in second subregion (wt%) | Content of binder in inorganic particles in second subregion (wt%) | Content of binder in polymer fibers in first subregion (wt%) | Content of binder in inorganic particles in first subregion (wt%) | Volume percent of inorganic particles in eparation layer | 300^{th}-cycle deformation rate of lithium-ion battery (%) | Volumetric energy density of battery discharged at 0.2 C (Wh/L) | 300^{th}-cycle capactiy retention rate (%) |
|---|---|---|---|---|---|---|---|---|---|---|---|
| Embodiment 19 | 17 | 15 | 2 | 17 | 4.8 | 14.4 | 4.5 | 17 | 7.4 | 720.6 | 91.6 |
| Embodiment 20 | 18 | 13 | 5 | 17 | 4.8 | 10.6 | 4.4 | 17 | 7.9 | 718.4 | 90.8 |
| Embodiment 21 | 19 | 12 | 7 | 17 | 4.8 | 9.3 | 4.1 | 17 | 8.2 | 716.8 | 89.6 |

As can be seen from Embodiments 1 to 21 versus Comparative Embodiments 1, 2, and 4, for a lithium-ion battery containing the separation layer according to this application, the deformation rate of the lithium-ion battery at the end of 300 cycles is reduced significantly, indicating that the lithium-ion battery according to this application is deformed to a smaller extent after repeated cycles and therefore is safer.

As can be seen from Embodiments 1 to 21 versus Comparative Embodiments 1 to 3, for a lithium-ion battery containing the separation layer according to this application, the volumetric energy density of the lithium-ion battery discharged at 0.2 C is improved significantly, indicating that the lithium-ion battery according to this application achieves a very high energy density.

As can be seen from Embodiments 1 to 15 and 17 to 20 versus Comparative Embodiments 1 to 4, for a lithium-ion battery containing the separation layer according to this application, the cycle capacity retention rate is improved, indicating that the lithium-ion battery according to this application is not only excellent in resisting deformation but also achieves a very long lifespan.

The volume percent of inorganic particles in the separation layer usually affects the strength of the separation layer. The thickness of the separation layer usually affects the strength and bonding performance of the separation layer. The porosity usually affects the air permeability of the separation layer. The fiber diameter of the polymer fibers usually affects the strength of the separation layer. The average particle diameter of the inorganic particles usually affects the bonding performance of the separation layer. As can be seen from Embodiments 1 to 21, as long as the above parameter values fall within the range specified in this application, the interfacial bonding force varies between different regions in the lithium-ion battery. Specifically, the bonding force of the separation layer to the surface of the electrode plate in the first region of the lithium-ion battery is greater than the bonding force of the separation layer to the surface of the electrode plate in the second region. In this way, the bonding force of the separation layer to the surface of the electrode plate in the first subregion in the first region is greater than the bonding force of the separation layer to the surface of the electrode plate in the second subregion. Therefore, the lithium-ion battery achieves a lower deformation rate and achieves the objectives of this application.

What is described above is merely exemplary embodiments of this application, but is not intended to limit this application. Any modifications, equivalent replacements, improvements, and the like made without departing from the spirit and principles of this application still fall within the protection scope of this application.

1. A jelly-roll type electrode assembly, comprising an electrode plate and a separation layer disposed on at least one surface of the electrode plate, wherein the j elly-roll type electrode assembly comprises a first region and a second region; a bonding force of the separation layer to a surface of the electrode plate in the first region is greater than a bonding force of the separation layer to the surface of the electrode plate in the second region; and the second region is a rollback region of the j elly-roll type electrode assembly.

2. The jelly-roll type electrode assembly according to claim 1, wherein a difference between the bonding force F1 of the separation layer to the surface of the electrode plate in the first region and the bonding force F2 of the separation layer to the surface of the electrode plate in the second region is 1 N/m to 15 N/m.

3. The jelly-roll type electrode assembly according to claim 1, wherein a difference between the bonding force F1 of the separation layer to the surface of the electrode plate in the first region and the bonding force F2 of the separation layer to the surface of the electrode plate in the second region is 5 N/m to 10 N/m.

4. The jelly-roll type electrode assembly according to claim 1, wherein the bonding force F1 of the separation layer to the surface of the electrode plate in the first region is 1 N/m to 30 N/m.

5. The jelly-roll type electrode assembly according to claim 4, wherein the bonding force F1 of the separation layer to the surface of the electrode plate in the first region is 10 N/m to 20 N/m.

6. The jelly-roll type electrode assembly according to claim 1, wherein the first region comprises a first subregion and a second subregion, a bonding force F3 of the separation layer to the electrode plate in the second subregion is greater than a bonding force F4 of the separation layer to the electrode plate in the first subregion, and the first subregion is a tab region of the j elly-roll type electrode assembly.

7. The j elly-roll type electrode assembly according to claim 1, wherein the separation layer comprises polymer fibers; the polymer fibers comprise a binder; in the first region, a content of the binder in the polymer fibers is 5 wt% to 25 wt%; and, in the second region, the content of the binder in the polymer fibers is 2 wt% to 20 wt%.

8. The j elly-roll type electrode assembly according to claim 7, wherein the polymer fibers further comprise an inorganic filler, and a content of the inorganic filler in the polymer fibers is 5 wt% to 10 wt%.

9. The jelly-roll type electrode assembly according to claim 7, wherein the separation layer further comprises inorganic particles, and a percentage of a volume of the inorganic particles in a total volume of solid matter in the separation layer is not greater than 40%.

10. The jelly-roll type electrode assembly according to claim 9, wherein the inorganic particles comprise a binder; in the first region, a content of the binder in the inorganic particles is 4 wt% to 7 wt%; and, in the second region, the content of the binder in the inorganic particles is 3 wt% to 15 wt%.

11. The j elly-roll type electrode assembly according to claim 1, wherein a positive tab and a negative tab of the j elly-roll type electrode assembly are disposed in the second region.

12. The j elly-roll type electrode assembly according to claim 7, wherein the polymer fibers comprise fibers of at least one of: polyvinylidene fluoride, polyimide, polyamide, polyacrylonitrile, polyethylene glycol, polyethylene oxide, polyphenylene ether, polypropylene carbonate, polymethyl methacrylate, polyethylene terephthalate, poly(vinylidene fluoride-co-hexafluoropropylene), poly(vinylidene difluoride-co-chlorotrifluoroethylene), or a derivative thereof.

13. The jelly-roll type electrode assembly according to claim 9, wherein the inorganic particles comprise at least one of: hafnium oxide, strontium titanium oxide, tin dioxide, cesium oxide, magnesium oxide, nickel oxide, calcium oxide, barium oxide, zinc oxide, zirconium oxide, yttrium oxide, aluminum oxide, titanium oxide, silicon dioxide, boehmite, magnesium hydroxide, aluminum hydroxide, lithium phosphate, lithium titanium phosphate, lithium aluminum titanium phosphate, lithium lanthanum titanate, lithium germanium thiophosphate, lithium nitride, SiS₂ glass, P₂S₅ glass, lithium oxide, lithium fluoride, lithium hydroxide, lithium carbonate, lithium metaaluminate, lithium germanium phosphorus sulfur ceramics, or garnet ceramics.

14. The jelly-roll type electrode assembly according to claim 7, wherein the binder comprises at least one of: polyvinyl alcohol, polytetrafluoroethylene, styrene-butadiene rubber, sodium carboxymethyl cellulose, polyacrylic acid, poly(butyl acrylate), polyacrylonitrile, polyurethane, or acrylonitrile multi-polymer.

15. The j elly-roll type electrode assembly according to claim 1, wherein the j elly-roll type electrode assembly satisfies at least one of the following features:
(a) a fiber diameter of polymer fibers in the separation layer is 10 nm to 5 µm;
(b) a thickness of the separation layer is 1 µm to 50 µm;
(c) an average particle diameter of inorganic particles in the separation layer is 20 nm to 5 µm; and
(d) a percentage of a volume of the inorganic particles in the separation layer in a total volume of solid matter in the separation layer is 15% to 30%.

16. An electronic device, comprising an electrochemical device, the electrochemical device comprises the jelly-roll type electrode assembly according to claim 1.
